(19) United States
(12) Patent Application Publication
(10) Pub. No.: US 2007/0022314 A1
(43) Pub. Date: Jan. 25, 2007

(54) Architecture and method for configuring a simplified cluster over a network with fencing and quorum

(76) Inventors: Pranoop Erasani, Sunnyvale, CA (US); Stephen Daniel, Durham, NC (US); Clifford Conklin, Durham, NC (US); Thomas Haynes, Tulsa, OK (US)

Correspondence Address: CESARI AND MCKENNA, LLP, 88 BLACK FALCON AVENUE, BOSTON, MA, 02210, US

(21) Appl. No.: 11/187,729

(22) Filed: Jul. 22, 2005

(51) Int. Cl. G06F 11/00

(52) U.S. Cl. 714/4

(57) ABSTRACT

A host-clustered networked storage environment includes a “quorum program.” The quorum program is invoked when a change in cluster membership occurs, or when the cluster members are not receiving reliable information about the continued viability of the cluster, or for a variety of other reasons. When the quorum program is so invoked, the cluster member is programmed to assert a claim on a quorum device configured in accordance with the present invention. More specifically, the quorum device is a vdisk embodied in as a logical unit (LUN) exported by the networked storage system. The LUN is created as a quorum device upon which a SCSI-3 reservation can be placed by an initiator. Thus, the LUN is created for this purpose as a SCSI target that exists solely as a quorum device. Fencing techniques are also provided in the networked environment such that failed cluster members can be fenced from given—exports of the networked—storage system.

### BACKGROUND OF THE INVENTION

1. Field of the Invention

This invention relates to data storage systems and more particularly to providing failure fencing of network files and quorum capability in a simplified networked data storage system.

2. Background Information

A storage system is a computer that provides storage service relating to the organization of information on writable persistent storage devices, such as memories, tapes or disks. The storage system is commonly deployed within a storage area network (SAN) or a network attached storage (NAS) environment. When used within a NAS environment, the storage system may be embodied as a storage system including an operating system that implements a file system to logically organize the information as a hierarchical structure of directories and files on, e.g. the disks. Each “on-disk” file may be implemented as a set of data structures, e.g., disk blocks, configured to store information, such as the actual data for the file. A directory, on the other hand, may be implemented as a specially formatted file in which information about other files and directories are stored.

In the client/server model, the client may comprise an application executing on a computer that “connects” to a storage system over a computer network, such as a point-to-point link, shared local area network, wide area network or virtual private network implemented over a public network, such as the Internet. NAS systems generally utilize file-based access protocols; therefore, each client may request the services of the storage system by issuing file system protocol messages (in the form of packets) to the file system over the network. By supporting a plurality of file system protocols, such as the conventional Common Internet File System (CIFS), the Network File System (NFS) and the Direct Access File System (DAFS) protocols, the utility of the storage system may be enhanced for networking clients.

A SAN is a high-speed network that enables establishment of direct connections between a storage system and its storage devices. The SAN may thus be viewed as an extension to a storage bus and, as such, an operating system of the storage system (a storage operating system, as hereinafter defined) enables access to stored information using block-based access protocols over the “extended bus.” In this context, the extended bus is typically embodied as Fiber Channel (FC) or Ethernet media (i.e., network) adapted to operate with block access protocols, such as Small Computer Systems Interface (SCSI) protocol encapsulation over FC or TCP/IP/Ethernet.

A SAN arrangement or deployment allows decoupling of storage from the storage system, such as an application server, and placing of that storage on a network. However, the SAN storage system typically manages specifically assigned storage resources. Although storage can be grouped (or pooled) into zones (e.g., through conventional logical unit number or “lun” zoning, masking and management techniques), the storage devices are still pre-assigned by a user that has administrative privileges, (e.g., a storage system administrator, as defined hereinafter) to the storage system.

Thus, the storage system, as used herein, may operate in any type of configuration including a NAS arrangement, a SAN arrangement, or a hybrid storage system that incorporates both NAS and SAN aspects of storage.

Access to disks by the storage system is governed by an associated “storage operating system,” which generally refers to the computer-executable code operable on a storage system that manages data access, and may implement file system semantics. In this sense, the NetApp® Data ONTAP™ operating system available from Network Appliance, Inc., of Sunnyvale, Calif. that implements the Write Anywhere File Layout (WAFL™) file system is an example of such a storage operating system implemented as a microkernel. The storage operating system can also be implemented as an application program operating over a general-purpose operating system, such as UNIX® or Windows NT®, or as a general-purpose operating system with configurable functionality, which is configured for storage applications as described herein.

In many high availability server environments, clients requesting services from applications whose data is stored on a storage system are typically served by coupled server nodes that are clustered into one or more groups. Examples of these node groups are Unix®-based host-clustering products. The groups typically share access to the data stored on the storage system from a direct access storage/storage area network (DAS/SAN). Typically, there is a communication link configured to transport signals, such as a heartbeat, between nodes such that during normal operations, each node has notice that the other nodes are in operation.

The absence of a heartbeat signal indicates to a node that there has been a failure of some kind. Typically, only one member should be allowed access to the shared storage system. In order to resolve which of the two nodes can continue to gain access to the storage system, each node is typically directly coupled to a dedicated disk assigned for the purpose of determining access to the storage system. When a node is notified of a failure of another node, or detects the absence of the heartbeat from that node, the detecting node asserts a claim upon the disk. The node that asserts a claim to the disk first is granted continued access to the storage system. Depending on how the host-cluster framework is implemented, the node(s) that failed to assert a claim over the disk may have to leave the cluster. This can be achieved by the failed node committing “suicide,” as will be understood by those skilled in the art, or by being explicitly terminated. Hence, the disk helps in determining the new membership of the cluster. Thus, the new membership of the cluster receives and transmits data requests from its respective client to the associated DAS storage system with which it is interfaced without interruption.

Typically, storage systems that are interfaced with multiple independent clustered hosts use Small Computer System Interface (SCSI) reservations to place a reservation on the disk to gain access to the storage system. However, messages which assert such reservations are usually made over a SCSI transport bus, which has a finite length. Such SCSI transport coupling has a maximum operable length, which thus limits the distance by which a cluster of nodes can be geographically distributed. And yet, wide geographic distribution is sometimes important in a high availability environment to provide fault tolerance in case of a catastrophic failure in one geographic location. For example, a node may be located in one geographic location that experiences a large-scale power failure. It would be advantageous in such an instance to have redundant nodes deployed in different locations. In other words, in a high availability environment, it is desirable that one or more clusters or nodes are deployed in a geographic location which is widely distributed from the other nodes to avoid a catastrophic failure.

However, in terms of providing access for such clusters, the typical reservation mechanism is not suitable due to the finite length of the SCSI bus. In some instances, a fiber channel coupling could be used to couple the disk to the nodes. Although this may provide some additional distance, the fiber channel coupling itself can be comparatively expensive and has its own limitations with respect to length.

To further provide protection in the event of failed nodes, fencing techniques are employed. However such fencing techniques had not generally been available to a host-cluster where the cluster is operating in a networked storage environment. A fencing technique for use in a networked storage environment is described in co-pending, commonly-owned U.S. Patent Application No. [Attorney Docket No. 112056-0236; P01-2299] of Erasani et al., for A CLIENT FAILURE FENCING MECHANISM FOR FENCING NETWORKED FILE SYSTEM DATA IN HOST-CLUSTER ENVIRONMENT, filed on even date herewith, which is presently incorporated by reference as though fully set forth herein, and U.S. Patent Application No. [Attorney Docket No. 112056-0237; P01-2252] for a SERVER API FOR FENCING CLUSTER HOSTS VIA EXPORT ACCESS RIGHTS, of Thomas Haynes et al., filed on even date herewith, which is also incorporated by reference as though fully set forth herein.

There remains a need, therefore, for an improved architecture for a networked storage system having a host-clustered client which has a facility for determining which node has continued access to the storage system, that does not require a directly attached disk.

There remains a further need for such a networked storage system, which also includes a feature that provides a technique for restricting access to certain data of the storage system.

### SUMMARY OF THE INVENTION

The present invention overcomes the disadvantages of the prior art by providing a clustered networked storage environment that includes a quorum facility that supports a file system protocol, such as the network file system (NFS) protocol, as a shared data source in a clustered environment. A plurality of nodes interconnected as a cluster is configured to utilize the storage services provided by an associated networked storage system. Each node in the cluster is an identically configured redundant node that may be utilized in the case of failover or for load balancing with respect to the other nodes in the cluster. The nodes are hereinafter referred to as a “cluster members.” Each cluster member is supervised and controlled by cluster software executing on one or more processors in the cluster member. As described in further detail herein, cluster membership is also controlled by an associated network accessed quorum device. The arrangement of the nodes in the cluster, and the cluster software executing on each of the nodes, as well as the quorum device, are hereinafter collectively referred to as the “cluster infrastructure.”

The clusters are coupled with the associated storage system through an appropriate network such as a wide area network, a virtual private network implemented over a public network (Internet), or a shared local area network. For a networked environment, the clients are typically configured to access information stored on the storage system as directories and files. The cluster members typically communicate with the storage system over a network by exchanging discreet frames or packets of data according to predefined protocols, such as the NFS over Transmission Control Protocol/Internet Protocol (TCP/IP).

According to illustrative embodiments of the present invention, each cluster member further includes a novel set of software instructions referred to herein as the “quorum program”. The quorum program is invoked when a change in cluster membership occurs, or when the cluster members are not receiving reliable information about the continued viability of the cluster, or for a variety of other reasons. When the quorum program is so invoked, the cluster member is programmed to assert a claim on the quorum device configured in accordance with the present invention. The node asserts a claim on the quorum device, illustratively by attempting to place a SCSI reservation on the device. More specifically, the quorum device is a virtual disk embodied in a logical unit (LUN) exported by the networked storage system. The LUN is created as a quorum device upon which a SCSI-3 reservation can be placed by an initiator. Thus, the LUN is created for this purpose as a SCSI target that exists solely as a quorum device.

In accordance with illustrative embodiments of the invention, the storage system generates the LUN as the quorum device as an export to the clustered host side of the environment. A cluster member asserting a claim on the quorum device is an initiator and communicates with the SCSI target quorum device by establishing an iSCSI session. The iSCSI session provides a communication path between the cluster member initiator and the quorum device target a TCP connection. The TCP connection is provided for by the network which couples the storage system to the host clustered side of the environment.

As used herein, establishing “quorum” means that in a two node cluster, the surviving node places a SCSI reservation on the LUN acting as the quorum device and thereby maintains continued access to the storage system. In a multiple node cluster, i.e., greater than two nodes, several cluster members can have registrations with the quorum device, but only one will be able to place a reservation on the quorum device. In the case of multiple node partition, i.e the cluster is partitioned in to two sub-clusters of two or more cluster members each, then each of the sub-clusters nominate a cluster member from their group to place the reservation and clear registrations of the “losing” cluster members. Those that are successful in having their representative node place the reservation first, thus establish a “quorum,” which is a new cluster that has continued access to the storage system,

In accordance one embodiment of the invention, SCSI Persistent Reservations are used by cluster members to assert a claim on the quorum device. Illustratively, only one Persistent Reservation command will occur during any one session. Accordingly, the sequence for invocation of the novel quorum program is to open an iSCSI session, send a command regarding a SCSI reservation of the quorum device (LUN), and wait for a response. The response is either that the SCSI reservation is successful and that cluster member now holds the quorum or that the reservation was unsuccessful and that cluster member must standby for further instruction. After obtaining a response, the cluster member which opened the iSCSI session then closes the session. The quorum program is a simple user interface that can be readily provided on the host side of the storage environment. Certain required configuration on the storage system side is also provided as described further herein. For example, the LUN which is created as the quorum device is mapped to the cluster members that are allowed access to it. This group of cluster members thus functions as an iSCSI group of initiators. In accordance with another aspect of the present invention, the quorum program can be configured to use SCSI Reserve/Release reservations, instead of Persistent Reservations.

Further details regarding creating a LUN and mapping that LUN to a particular client on a storage system are provided in commonly owned U.S. patent application Ser. No. 10/619,122 filed on Jul. 14, 2003, by Lee et al., for SYSTEM AND MESSAGE FOR OPTIMIZED LUN MASKING, which is presently incorporated herein as though fully set forth in its entirety.

By utilizing the teachings of the present invention, the present invention allows SCSI reservation techniques to be employed in a networked storage environment, to provide a quorum facility for clustered-hosts associated of the storage system.

### BRIEF DESCRIPTION OF THE DRAWINGS

The above and further advantages of the invention may be understood by referring to the following description in conjunction with the accompanying drawings in which like reference numerals indicate identical or functionally similar elements:

FIG. 1 is a schematic block diagram of a prior art storage system which utilizes a directly attached quorum disk;

FIG. 2 is a schematic block diagram of a prior art storage system which uses a remotely deployed quorum disk that is coupled to each cluster member via fiber channel;

FIG. 3 is a schematic block diagram of an exemplary storage system environment for use with an illustrative embodiment of the present invention;

FIG. 4 is a schematic block diagram of the storage system with which the present invention can be used;

FIG. 5 is a schematic block diagram of the storage operating system in accordance with the embodiment of the present invention;

FIG. 6 is a flow chart detailing the steps of a procedure performed for configuring the storage system and creating the LUN to be used as the quorum device in accordance with an embodiment of the present invention;

FIG. 7 is a flow chart detailing the steps of a procedure for downloading parameters into cluster members for a user interface in accordance with an embodiment of the present invention;

FIG. 8 is a flow chart detailing the steps of a procedure for processing a SCSI reservation command directed to a LUN created in accordance with an embodiment of the present invention; and

FIG. 9 is a flowchart detailing the steps of a procedure for an overall process for a simplified architecture for providing fencing techniques and a quorum facility in a network-attached storage system in accordance with an embodiment of the present invention.

### DETAILED DESCRIPTION OF AN ILLUSTRATIVE EMBODIMENT

A. Cluster Environment

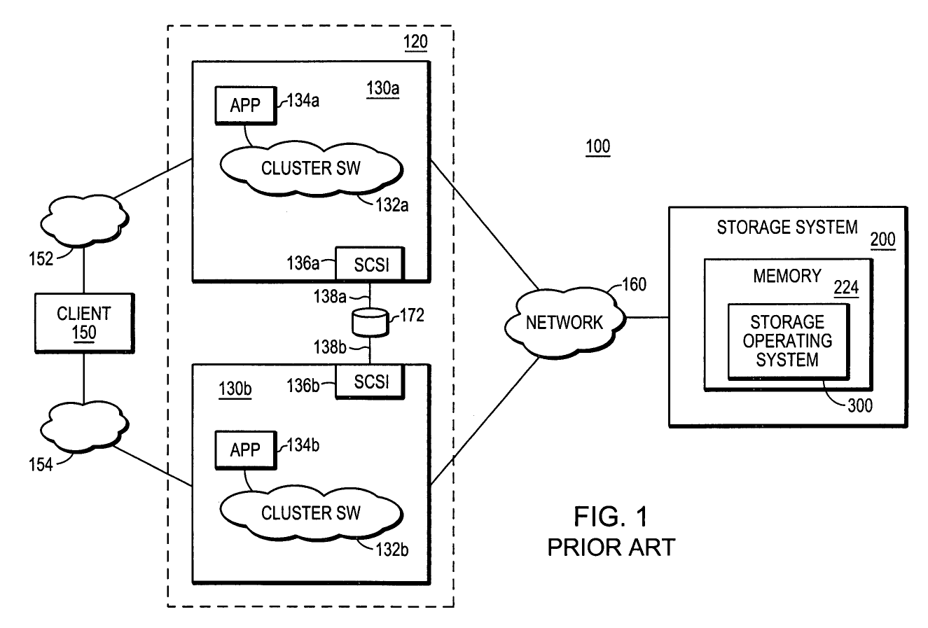

FIG. 1 is a schematic block diagram of a storage environment 100 that includes a cluster 120 having nodes, referred to herein as “cluster members” 130a and 130b, each of which is an identically configured redundant node that utilizes the storage services of an associated storage system 200. For purposes of clarity of illustration, the cluster 120 is depicted as a two-node cluster, however, the architecture of the environment 100 can vary from that shown while remaining within the scope of the present invention. The present invention is described below with reference to an illustrative two-node cluster; however, clusters can be made up of three, four or many nodes. In cases in which there is a cluster having a number of members that is greater than two, a quorum disk may not be needed. In some other instances, however, in clusters having more than two nodes, the cluster may still use a quorum disk to grant access to the storage system for various reasons. Thus, the solution provided by the present invention can also be applied to clusters comprised of more than two nodes.

Cluster members 130a and 130b comprise various functional components that cooperate to provide data from storage devices of the storage system 200 to a client 150. The cluster member 130a includes a plurality of ports that couple the member to the client 150 over a computer network 152. Similarly, the cluster member 130b includes a plurality of ports that couple that member with the client 150 over a computer network 154. In addition, each cluster member 130, for example, has a second set of ports that connect the cluster member to the storage system 200 by way of a network 160. The cluster members 130a and 130b, in the illustrative example, communicate over the network 160 using Transmission Control Protocol/Internet Protocol (TCP/IP). It should be understood that although networks 152, 154 and 160 are depicted in FIG. 1 as individual networks, these networks may in fact comprise a single network or any number of multiple networks, and the cluster members 130a and 130b can be interfaced with one or more of such networks in a variety of configurations while remaining within the scope of the present invention.

In addition to the ports which couple the cluster member 130a to the client 150 and to the network 160, the cluster member 130a also has a number of program modules executing thereon. For example, cluster software 132a performs overall configuration, supervision and control of the operation of the cluster member 130a. An application 134a running on the cluster member 130a communicates with the cluster software to perform the specific fiction of the application running on the cluster member 130a. This application 134a may be, for example, an Oracle® database application.

In addition, a SCSI-3 protocol driver 136a is provided as a mechanism by which the cluster member 130a acts as an initiator and accesses data provided by a data server, or “target.” The target in this instance is a directly coupled, directly attached quorum disk 172. Thus, using the SCSI protocol driver 136a and the associated SCSI bus 138a, the cluster 130a can attempt to place a SCSI-3 reservation on the quorum disk 172. As noted before, however, the SCSI bus 138a has a particular maximum usable length for its effectiveness. Therefore, there is only a certain distance by which the cluster member 130a can be separated from its directly attached quorum disk 172.

Similarly, cluster member 130b includes cluster software 132b which is in communication with an application program 134b. The cluster member 130b is directly attached to quorum disk 172 in the same manner as cluster member 130a. Consequently, cluster members 130a and 130b must be within a particular distance of the directly attached quorum disk 172, and thus within a particular distance of each other. This limits the geographic distribution physically attainable by the cluster architecture.

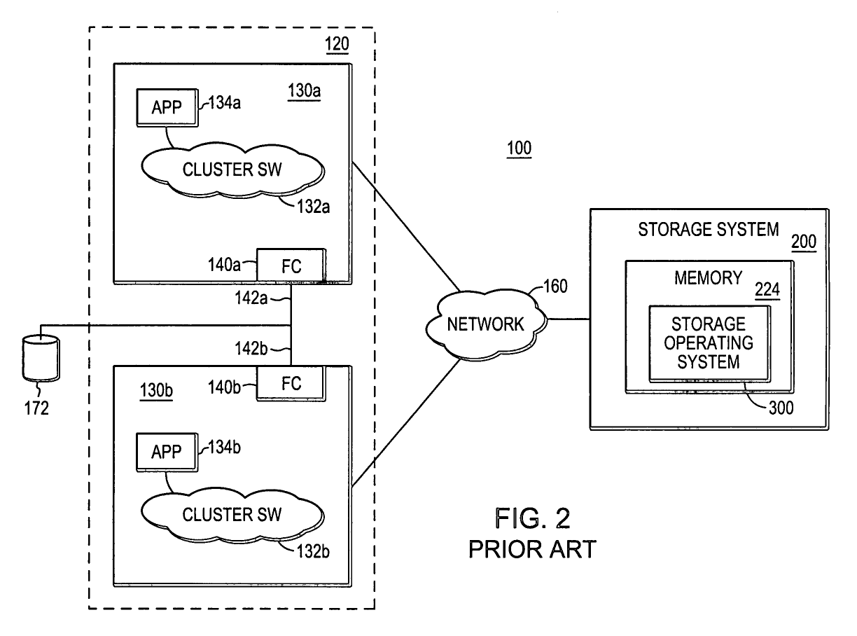

Another example of a prior art system is provided in FIG. 2, in which like components have the same reference characters as in FIG. 1. It is noted however, that the client 150 and the associated networks have been omitted from FIG. 2 for clarity of illustration; it should be understood that a client is being served by the cluster 120.

In the prior art, system illustrated in FIG. 2, cluster members 130a and 130b are coupled to a directly attached quorum disk 172. In this system, cluster member 130a, for example, has a fiber channel driver 140a providing fiber channel-specific access to a quorum disk 172, via fiber channel coupling 142a. Similarly, cluster member 130b has a fiber channel driver 140b, which provides fiber channel- specific access to the disk 172 by fiber channel coupling 142b. Though it allows some additional distance of separation from cluster members 130a and 130b, the fiber channel coupling 142a and 142b is particularly costly and could result in significantly increased costs in a large deployment.

Thus, it should be understood that the systems of FIG. 1 and FIG. 2 have disadvantages in that they impose geographical imitations or higher costs, or both.

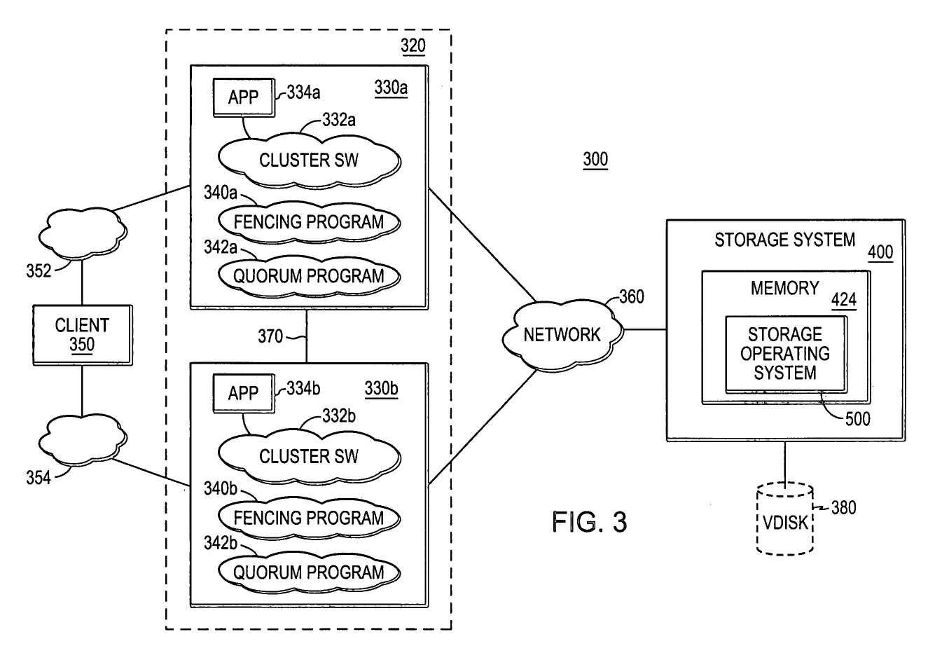

In accordance with illustrative embodiments of the present invention, FIG. 3 is a schematic block diagram of a storage environment 300 that includes a cluster 320 having cluster members 330a and 330b, each of which is in an identically configured redundant node that utilizes the storage services of an associated storage system 400. For purposes of clarity of illustration, the cluster 320 is depicted as a two-node cluster, however, the architecture of the environment 300 can widely vary from that shown while remaining within the scope of the present invention.

Cluster members 330a and 330b comprise various functional components that cooperate to provide data from storage devices of the storage system 400 to a client 350. The cluster member 330a includes a plurality of ports that couple the member to the client 350 over a computer network 352. Similarly, the cluster member 330b includes a plurality of ports that couple the member to the client 350 over a computer network 354. In addition, each cluster member 330a and 330b, for example, has a second set of ports that connect the cluster member to the storage system 400 by way of network 360. The cluster members 330a and 330b, in the illustrative example, communicate over the network 360 using TCP/IP. It should be understood that although networks 352, 354 and 360 are depicted in FIG. 3 as individual networks, these networks may in fact comprise a single network or any number of multiple networks, and the cluster members 330a and 330b can be interfaced with one or more such networks in a variety of configurations while remaining within the scope of the present invention.

In addition to the ports which couple the cluster member 330a, for example, to the client 350 and to the network 360, the cluster member 330a also has a number of program modules executing thereon. For example, cluster software 332a performs overall configuration, supervision and control of the operation of the cluster member 330a. An application 334a, running on the cluster 330a communicates with the cluster software to perform the specific function of the application running on the cluster member 330a. This application 334a may be, for example, an Oracle® database application. In addition, fencing program 340a described in the above-identified commonly-owned U.S. Patent Application No. [Attorney Docket No. 112056-0236; P01-2299] is provided. The fencing program 340a allows the cluster member 330a to send fencing instructions to the storage system 400. More specifically, when cluster membership changes, such as when a cluster member fails, or upon the addition of a new cluster member, or upon a failure of the communication link between cluster members, for example, it may be desirable to “fence off” a failed cluster member to avoid that cluster member writing spurious data to a disk, for example. In this case, the fencing program executing on a cluster member not affected by the change in cluster membership (i.e., the “surviving” cluster member) notifies the NFS server in the storage system that a modification must be made in one of the export lists such that a target cluster member, for example, cannot write to given exports of the storage system, thereby fencing off that member from that data. The notification is to change the export lists within an export module of the storage system 400 in such a manner that the cluster member can no longer have write access to particular exports in the storage system 400. In addition, in accordance with an illustrative embodiment of the invention, the cluster member 330a also includes a quorum program 342a as described in further detail herein.

Similarly, cluster member 330b includes cluster software 332b which is in communication with an application program 334b. A fencing program 340b as herein before described, executes on the cluster member 330b. The cluster members 330a and 330b are illustratively coupled by cluster interconnect 370 across which identification signals, such as a heartbeat, from the other cluster member will indicate the existence and continued viability of the other cluster member.

Cluster member 330b also has a quorum program 342b in accordance with the present invention executing thereon. The quorum programs 342a and 342b communicate over a network 360 with a storage system 400. These communications include asserting a claim upon the vdisk (LUN) 380, which acts as the quorum device in accordance with an embodiment in the present invention as described in further detain hereinafter. Other communications can also occur between the cluster members 330a and 330b and the LUN serving as quorum device 380 within the scope of the present invention. These other communications include test messages.

B. Storage System

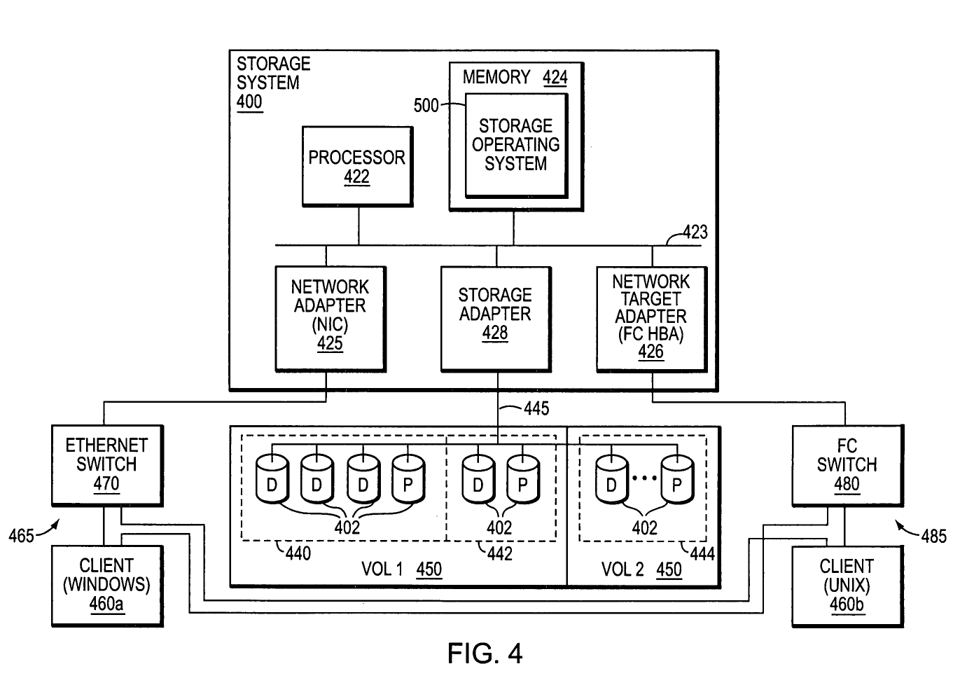

FIG. 4 is a schematic block diagram of a multi-protocol storage system 400 configured to provide storage service relating to the organization of information on storage devices, such as disks 402. The storage system 400 is illustratively embodied as a storage appliance comprising a processor 422, a memory 424, a plurality of network adapters 425, 426 and a storage adapter 428 interconnected by a system bus 423. The multi-protocol storage system 400 also includes a storage operating system 500 that provides a virtualization system (and, in particular, a file system) to logically organize the information as a hierarchical structure of named directory, file and virtual disk (vdisk) storage objects on the disks 402.

Whereas clients of a NAS-based network environment have a storage viewpoint of files, the clients of a SAN-based network environment have a storage viewpoint of blocks or disks. To that end, the multi-protocol storage system 400 presents (exports) disks to SAN clients through the creation of LUNs or vdisk objects. A vdisk object (hereinafter “vdisk”) is a special file type that is implemented by the virtualization system and translated into an emulated disk as viewed by the SAN clients. The multi-protocol storage system thereafter makes these emulated disks accessible to the SAN clients through controlled exports, as described further herein.

In the illustrative embodiment, the memory 424 comprises storage locations that are addressable by the processor and adapters for storing software program code and data structures. The processor and adapters may, in turn, comprise processing elements and/or logic circuitry configured to execute the software code and manipulate the various data structures. The storage operating system 500, portions of which are typically resident in memory and executed by the processing elements, functionally organizes the storage system by, inter alia, invoking storage operations in support of the storage service implemented by the system. It will be apparent to those skilled in the art that other processing and memory implementations, including various computer readable media, may be used for storing and executing program instructions pertaining to the inventive system and method described herein.

The network adapter 425 couples the storage system to a plurality of clients 460a,b over point-to-point links, wide area networks, virtual private networks implemented over a public network (Internet) or a shared local area network, hereinafter referred to as an illustrative Ethernet network 465. Therefore, the network adapter 425 may comprise a network interface card (NIC) having the mechanical, electrical and signaling circuitry needed to connect the system to a network switch, such as a conventional Ethernet switch 470. For this NAS-based network environment, the clients are configured to access information stored on the multi-protocol system as files. The clients 460 communicate with the storage system over network 465 by exchanging discrete frames or packets of data according to pre-defined protocols, such as the Transmission Control Protocol/Internet Protocol (TCP/IP).

The clients 460 may be general-purpose computers configured to execute applications over a variety of operating systems, including the UNIX® and Microsoft® Windows™ operating systems. Client systems generally utilize file-based access protocols when accessing information (in the form of files and directories) over a NAS-based network. Therefore, each client 460 may request the services of the storage system 400 by issuing file access protocol messages (in the form of packets) to the system over the network 465. For example, a client 460a running the Windows operating system may communicate with the storage system 400 using the Common Internet File System (CIFS) protocol. On the other hand, a client 460b running the UNIX operating system may communicate with the multi-protocol system using either the Network File System (NFS) protocol over TCP/IP or the Direct Access File System (DAFS) protocol over a virtual interface (VI) transport in accordance with a remote DMA (RDMA) protocol over TCP/IP. It will be apparent to those skilled in the art that other clients running other types of operating systems may also communicate with the integrated multi-protocol storage system using other file access protocols.

The storage network “target” adapter 426 also couples the multi-protocol storage system 400 to clients 460 that may be further configured to access the stored information as blocks or disks. For this SAN-based network environment, the storage system is coupled to an illustrative Fiber Channel (FC) network 485. FC is a networking standard describing a suite of protocols and media that is primarily found in SAN deployments. The network target adapter 426 may comprise a FC host bus adapter (HBA) having the mechanical, electrical and signaling circuitry needed to connect the system 400 to a SAN network switch, such as a conventional FC switch 480.

The clients 460 generally utilize block-based access protocols, such as the Small Computer Systems Interface (SCSI) protocol, as discussed previously herein, when accessing information (in the form of blocks, disks or vdisks) over a SAN-based network. SCSI is a peripheral input/output (I/O) interface with a standard, device independent protocol that allows different peripheral devices, such as disks 402, to attach to the storage system 400. As noted herein, in SCSI terminology, clients 460 operating in a SAN environment are initiators that initiate requests and commands for data. The multi-protocol storage system is thus a target configured to respond to the requests issued by the initiators in accordance with a request/response protocol. The initiators and targets have end-point addresses that, in accordance with the FC protocol, comprise worldwide names (WWN). A WWN is a unique identifier, e.g., a Node Name or a Port Name, consisting of an 8-byte number.

The multi-protocol storage system 400 supports various SCSI-based protocols used in SAN deployments, and in other deployments including SCSI encapsulated over TCP (iSCSI) and SCSI encapsulated over FC (FCP). The initiators (hereinafter clients 460) may thus request the services of the target (hereinafter storage system 400) by issuing iSCSI and FCP messages over the network 465, 485 to access information stored on the disks. It will be apparent to those skilled in the art that the clients may also request the services of the integrated multi-protocol storage system using other block access protocols. By supporting a plurality of block access protocols, the multi-protocol storage system provides a unified and coherent access solution to vdisks/LUNs in a heterogeneous SAN environment.

The storage adapter 428 cooperates with the storage operating system 500 executing on the storage system to access information requested by the clients. The information may be stored on the disks 402 or other similar media adapted to store information. The storage adapter includes I/O interface circuitry that couples to the disks over an I/O interconnect arrangement, such as a conventional high-performance, FC serial link topology. The information is retrieved by the storage adapter and, if necessary, processed by the processor 422 (or the adapter 428 itself) prior to being forwarded over the system bus 423 to the network adapters 425, 426, where the information is formatted into packets or messages and returned to the clients.

Storage of information on the system 400 is preferably implemented as one or more storage volumes (e.g., VOL1-2450) that comprise a cluster of physical storage disks 402, defining an overall logical arrangement of disk space. The disks within a volume are typically organized as one or more groups of Redundant Array of Independent (or Inexpensive) Disks (RAID). RAID implementations enhance the reliability/integrity of data storage through the writing of data “stripes” across a given number of physical disks in the RAID group, and the appropriate storing of redundant information with respect to the striped data. The redundant information enables recovery of data lost when a storage device fails. It will be apparent to those skilled in the art that other redundancy techniques, such as mirroring, may be used in accordance with the present invention.

Specifically, each volume 450 is constructed from an array of physical disks 402 that are organized as RAID groups 440, 442, and 444. The physical disks of each RAID group include those disks configured to store striped data (D) and those configured to store parity (P) for the data, in accordance with an illustrative RAID 4 level configuration. It should be noted that other RAID level configurations (e.g. RAID 5) are also contemplated for use with the teachings described herein. In the illustrative embodiment, a minimum of one parity disk and one data disk may be employed. However, a typical implementation may include three data and one parity disk per RAID group and at least one RAID group per volume.

C. Storage Operating System

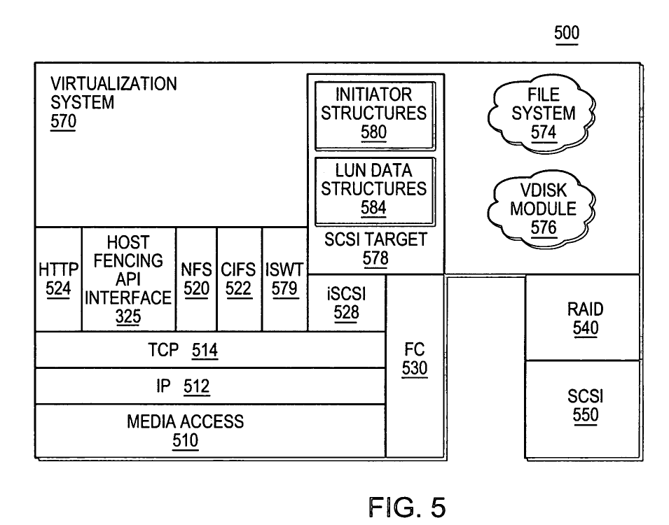

FIG. 5 is a schematic block diagram of an exemplary storage operating system 500 that may be advantageously used in the present invention. A storage operating system 500 comprises a series of software modules organized to form an integrated network protocol stack, or generally, a multi-protocol engine that provides data paths for clients to access information stored on the multi-protocol storage system 400 using block and file access protocols. The protocol stack includes media access layer 510 of network drivers (e.g., gigabit Ethernet drivers) that interfaces through network protocol layers, such as IP layer 512 and its supporting transport mechanism, the TCP layer 514. A file system protocol layer provides multi-protocol file access and, to that end, includes a support for the NFS protocol 520, the CIFS protocol 522, and the hypertext transfer protocol (HTTP) 524.

An iSCSI driver layer of 528 provides block protocol access over the TCP/IP network protocol layers, while an FC driver layer 530 operates with the network adapter to receive and transmit block access requests and responses to and from the storage system. The FC and iSCSI drivers provide FC-specific and iSCSI-specific access control to the LUNs (vdisks) and, thus, manage exports of vdisks to either iSCSI or FCP or, alternatively to both iSCSI and FCP when accessing a single vdisk on the storage system. In addition, the operating system includes a disk storage layer 540 that implements a disk storage protocol such as a RAID protocol, and a disk driver layer 550 that implements a disk access protocol such as, e.g. a SCSI protocol.

Bridging the disk software modules with the integrated network protocol stack layer is a virtualization system 570. The virtualization system 570 includes a file system 574 interacting with virtualization modules illustratively embodied as, e.g., vdisk module 576 and SCSI target module 578. Additionally, the SCSI target module 578 includes a set of initiator data structures 580 and a set of LUN data structures 584. These data structures store various configuration and tracking data utilized by the storage operating system for use with each initiator (client) and LUN (vdisk) associated with the storage system. Vdisk module 576, the file system 574, and the SCSI target module 578 can be implemented in software, hardware, firmware, or a combination thereof.

The vdisk module 576 communicates with the file system 574 to enable access by administrative interfaces in response to a storage system administrator issuing commands to a storage system 400. In essence, the vdisk module 576 manages all SAN deployments by, among other things, implementing a comprehensive set of vdisk (LUN) commands issued by the storage system administrator. These vdisk commands are converted into primitive file system operations (“primitives”) that interact with a file system 574 and the SCSI target module 578 to implement the vdisks. The SCSI target module 578 initiates emulation of a disk or LUN by providing a mapping and procedure that translates LUNs into the special vdisk file types. The SCSI target module is illustratively disposed between the FC and iSCSI drivers 530 and 528 respectively and file system 574 to thereby provide a translation layer of a virtualization system 570 between a SAN block (LUN) and a file system space, where LUNs are represented as vdisks. To that end, the SCSI target module 578 has a set of APIs that are based on the SCSI protocol that enable consistent interface to both the iSCSI and FC drivers 528, 530 respectively. An iSCSI Software Target (ISWT) driver 579 is provided in association with the SCSI target module 578 to allow iSCSI-driven messages to reach the SCSI target.

It is noted that by “disposing” SAN virtualization over the file system 574 the storage system 400 reverses approaches taken by prior systems to thereby provide a single unified storage platform for essentially all storage access protocols.

The file system 574 provides volume management capabilities for use in block based access to the information stored on the storage devices, such as disks. That is, in addition to providing file system semantics, such as naming of storage objects, the file system 574 provides functions normally associated with a volume manager. These functions include (i) aggregation of the disks, (ii) aggregation of the storage bandwidth of the disks, and (iii) reliability guarantees such as mirroring and/or parity (RAID) to thereby present one or more storage objects laid on the file system.

The file system 574 illustratively implements the WAFL® file system having in on disk format representation that is block based using, e.g., 4 kilobyte (KB) blocks and using inodes to describe files. The WAFL® file system uses files to store metadata describing the layout of its file system; these metadata files include, among others, an inode file. A file handle, i.e., an identifier that includes an inode number, is used to retrieve an inode from disk. A description of the structure of the file system, including on-disk inodes and the inode file, is provided in commonly owned U.S. Pat. No. 5,819,292, titled METHOD FOR MAINTAINING CONSISTENT STATES OF A FILE SYSTEM AND FOR CREATING USER-ACCESSIBLE READ-ONLY COPIES OF A FILE SYSTEM by David Hitz et al., issued Oct. 6, 1998, which patent is hereby incorporated by reference as though fully set forth herein.

It should be understood that the teachings of this invention can be employed in a hybrid system that includes several types of different storage environments such as the particular storage environment 300 of FIG. 3. The invention can be used by a storage system administrator that deploys a system implementing and controlling a plurality of satellite storage environments that, in turn, deploy thousands of drives in multiple networks that are geographically dispersed. Thus, the term “storage system” as used herein, should, therefore, be taken broadly to include such arrangements.

D. Quorum Facility

In an illustrative embodiment of the invention, a host-clustered storage environment includes a quorum facility that supports a file system protocol, such as the NFS protocol, as a shared data source in a clustered environment. A plurality of nodes interconnected as a cluster is configured to utilize the storage services provided by an associated networked storage system. Each node in the cluster, hereinafter referred to as a “cluster member,” is supervised and controlled by cluster software executing on one or more processors in the cluster member. As described in further detail herein, cluster membership is also controlled by an associated network accessed quorum device. The arrangement of the nodes in the cluster, and the cluster software executing on each of the nodes, as well as the quorum device, are hereinafter collectively referred to as the “cluster infrastructure.”

According to illustrative embodiments of the present invention, each cluster member further includes a novel set of software instructions referred to herein as the “quorum program.” The quorum program is invoked when a change in cluster membership occurs, or when the cluster members are not receiving reliable information about the continued viability of the cluster, or for a variety of other reasons. When the quorum program is so invoked, the cluster member is programmed to assert a claim on the quorum device configured in accordance with the present invention. The cluster member asserts a claim on the quorum device illustratively by attempting to place a SCSI reservation on the device. More specifically, the quorum device is a vdisk embodied in a LUN exported by the networked storage system. The LUN is created as a quorum device upon which a SCSI-3 reservation can be placed by an initiator. Thus, the LUN is created for this purpose as a SCSI target that exists solely as a quorum device.

In accordance with illustrative embodiments of the invention, the storage system generates the LUN as the quorum device as an export to the clustered host side of the environment. A cluster member asserting a claim on the quorum device, which is accomplished illustratively by placing a SCSI reservation on the LUN serving as a quorum device, is an initiator and communicates with the SCSI target quorum device by establishing an iSCSI session. The iSCSI session provides a communication path between the cluster member initiator and the quorum device target, preferably over a TCP connection. The TCP connection is provided for by the network which couples the storage system to the host clustered side of the environment.

For purposes of a more complete description, it is noted that a more recent version of the SCSI standard is known as SCSI-3. A target organizes and advertises the presence of data using containers called “logical units” (LUNs). An initiator requests services from a target by building a SCSI-3 “command descriptor block (CDB).” Some CDBs are used to write data within a LUN. Others are used to query the storage system to determine the available set of LUNs, or to clear error conditions and the like.

The SCSI-3 protocol defines the rules and procedures by which initiators request or receive services from targets. In a clustered environment, when a quorum facility is to be employed, cluster nodes are configured to act as “initiators” to assert claims on a quorum device that is the “target” using a SCSI-3 based reservation mechanism. The quorum device in that instance acts as a tie breaker in the event of failure and insures that the sub-cluster that has the claim upon the quorum disk will be the one to survive. This ensures that multiple independent clusters do not survive in case of a cluster failure. To allow otherwise, could mean that a failed cluster member may continue to survive, but may send spurious messages and possibly write incorrect data to one or more disks of the storage system.

There are two different types of reservations supported by the SCSI-3 specification. The first type of reservation is known as SCSI Reserve/Release reservations. The second is known as Persistent Reservations. The two reservation schemes cannot be used together. If a disk is reserved using SCSI Reserve/Release, it will reject all Persistent Reservation commands. Likewise, if a drive is reserved using Persistent Reservation, it will reject SCSI Reserve/Release.

SCSI Reserve/Release is essentially a lock/unlock mechanism. SCSI Reserve locks a drive and SCSI Release unlocks it. A drive that is not reserved can be used by any initiator. However, once an initiator issues a SCSI Reserve command to a drive, the drive will only accept commands from that initiator. Therefore, only one initiator can access the device if there is a reservation on it. The device will reject most commands from other initiators (commands such as SCSI Inquiry will still be processed) until the initiator issues a SCSI Release command to it or the drive is reset through either a soft reset or a power cycle, as will be understood by those skilled in the art.

Persistent Reservations allow initiators to reserve and unreserve a drive similar to the SCSI Reserve/Release functionality. However, they also allow initiators to determine who has a reservation on a device and to break the reservation of another device, if needed. Reserving a device is a two step process. Each initiator can register a key (an eight byte number) with the device. Once the key is registered, the initiator can try to reserve that device. If there is already a reservation on the device, the initiator can preempt it and atomically change the reservation to claim it as its own. The initiator can also read off the key of another initiator holding a reservation, as well as a list of all other keys registered on the device. If the initiator is programmed to understand the format of the keys, it can determine who currently has the device reserved. Persistent Reservations support various access modes ranging from exclusive read/write to read-shared/write-exclusive for the device being reserved.

In accordance one embodiment of the invention, SCSI Persistent Reservations are used by cluster members to assert a claim on the quorum device. Illustratively, only one Persistent Reservation command will occur during any one session. Accordingly, the sequence for invocation of the novel quorum program is to open an iSCSI session, send a command regarding a SCSI reservation of the quorum device (LUN), and wait for a response. The response is either that the SCSI reservation is successful and that cluster member now holds the quorum or that the reservation was unsuccessful and that cluster member must standby for further instruction. After obtaining a response, the cluster member which opened the iSCSI session then closes the session. The quorum program is a user interface that can be readily provided on the host side of the storage environment. Certain required configuration on the storage system side is also provided as described further herein. For example, the LUN which is created as the quorum device is mapped to the cluster members that are allowed access to it. This group of cluster members thus functions as an iSCSI group of initiators. In accordance with another aspect of the present invention, the quorum program can be configured to use SCSI Reserve/Release reservations, instead of Persistent Reservations.

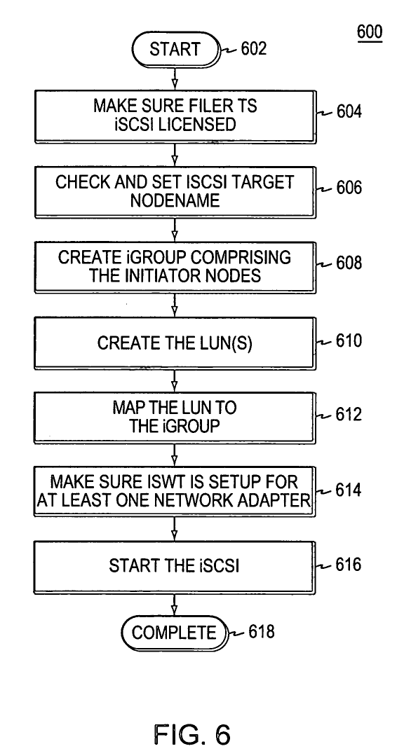

Furthermore, in accordance with the present invention, a basic configuration is required for the storage system before the quorum facility can be used for the intended purpose. This configuration includes creating the LUN that will be used as the quorum device in accordance with the invention. FIG. 6 illustrates a procedure 600, the steps of which can be used to implement the required configuration on the storage system. The procedure starts with step 602 and continues to steps 604. Step 604 requires that the storage system is iSCSI licensed. An exemplary command line for performing this step is as follows:
storagesystem>license add XXXXXX

In this command, where XXXXXX appears, the iSCSI license key should be inserted, as will be understood by those skilled in the art. It is noted that in another case, the general iSCSI access could be licensed, but specifically for quorum purposes. A separate license such as an “iSCSI admin” license can be issued royalty free, similar to certain HTTP licenses, as will be understood by those skilled in the art.

The next step 606 is to check and set the iSCSI target nodename. An exemplary command line for performing this step is as follows:
storagesystem>iscsi nodename

The programmer should insert the identification of the iSCSI target nodename which in this instance will be the name of the storage system. By way of example, the storage system name may have the following format, however, any suitable format may be used: iqn.1992-08.com.:s.335xxxxxx. Alternatively, the nodename may be entered by setting the hostname as the suffix instead of the serial number. The hostname can be used rather than iSCSI nodename of the storage system as the ISCSI target's address.

Step 608 provides that an igroup is to be created comprising the initiator nodes. The initiator nodes in the illustrative embodiment of the invention are the cluster members such as cluster members 330a and 330b of FIG. 3. If the initiator names for the cluster members for example, are iqn.1992-08.com.cl1 and iqn.1992.08.com.cl2, and the following command line can be used by way of example, to create an igroup in accordance with step 608:

```
Storagesystem>igroup create -i scntap-grp
    Storagesystem>igroup show
        scntap-grp (iSCSI) (os type: default):
  Storagesystem>igroup add scntap-grp iqn.1998-08.com.cl1
    Storagesystem>igroup add scntap-grp iqn.1192-08.com.cl2
        Storagesystem>igroup show scntap-grp
            scntap-grp (iSCSI) (ostype: default):
                iqn.1992-08.com.cl1
                iqn.1992-08.com.cl2
```

In accordance with step 610, the actual LUN is created. In certain embodiments of the invention, more than one LUN can be created if desired in a particular application of the invention. An exemplary command line for creating the LUN, which is illustratively located as \vol\vol0\scntaplun is as follows:

Storagesystem>lun create -s 1g\vol\vol0\scntaplun
Storagesystem>lun show
\vol\vol0\scntaplun 1g (1073741824) (r/w, online)

It is noted that steps 608 and 610 can be performed in either order. However, both must be successful before proceeding further. In step 612, the created LUN is mapped to the created igroup in step 608. This can be accomplished using the following command line:

StorageSystem>lun show -v\vol\vol0\scntaplun
\vol\vol0\sentaplun 1g (1073741824) (r−w, online)

Step 612 ensures that the LUN is available to the initiators in the specified group at the LUN ID as specified.

In accordance with step 614, the iSCSI Software Target (ISWT) driver is configured for at least one network adapter. As a target driver, part of the ISWT's responsibility is for driving certain hardware for the purposes of providing access to the storage system managed LUNs by the iSCSI initiators. This allows the storage system to provide the iSCSI target service over any or all of its standard network interfaces, and a single network interface can be used simultaneously for both iSCSI requests and other types of network traffic (e.g. NFS and or CIFS requests).

The command line which can be used to check the interface is as follows:
storagesystem>iscsi show adapter

This indicates which adapters are set up in step 614.

Now that the LUN has been mapped to the igroup and the iSCSI driver has been set up and implemented, the next step (step 616) is to start the iSCSI driver so that iSCSI client calls are ready to be served. At step 616, to start the iSCSI service the following command line can be used:
storagesystem>iscsi start.

The procedure 600 completes at step 618. The procedure thus creates the LUN to be used as a network-accessed quorum device in accordance with the invention and allows it come online and to be accessible so that it is ready when needed to establish for a quorum. As noted, in addition to providing a quorum facility, a LUN may also be created for other purposes which are implemented using the quorum program of the present invention as set forth in each of the cluster members that interface with the LUN.

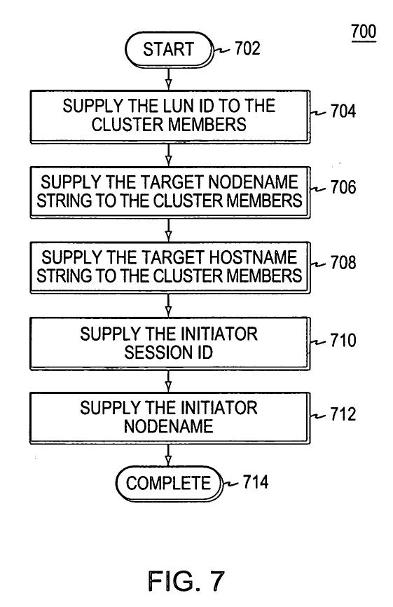

Once the storage system is appropriately configured, a user interface is to be downloaded from a storage system provider's website or in another suitable manner understood by those skilled in the art, into the individual cluster members that are to have the quorum facility associated herewith. This is illustrated in the flowchart 700 of FIG. 7. In another embodiment of the invention, the “quorum program” in one or more of the cluster members may be either accompanied by or replaced by a host-side iSCSI driver, such as iSCSI driver 136a (FIG. 1), which is configured access the LUN serving as the quorum disk in accordance with the present invention.

The procedure 700 begins with the start step 702 and continues to step 704 in which an iSCSI parameter is to be supplied at the administrator level. More specifically, step 704 indicates that the LUN ID should be supplied to the cluster members. This is the identification number of the target LUN in a storage system that is to act as the quorum device. This target LUN will have already been created and will have an identification number pursuant to the procedure 600 of FIG. 6.

In step 706, the next parameter that is to be supplied to the administrator is the target node name. The target nodename is a string which indicates the storage system which exports the LUN. A target nodename string may be, for example, “iqn.1992.08.com.sn.33583650”.

Next, the target hostname string is to be supplied to the cluster member in accordance with step 708. The target hostname string is simply the host name.

In accordance with step 710, the initiator session ID, or “ISID”, is to be supplied. This is a 6 byte initiator session ID which takes the form, for example: 11:22:33:44:55:66.

In accordance with step 712, the initiator nodename string is supplied, which indicates which cluster member is involved so that when a response is sent back to the cluster member from the storage system, the cluster member is appropriately identified and addressed. The initiator nodename string may be for example “iqn. 1992.08.com.itst”.

The setup procedure of 700 of FIG. 7 completes at step 714.

Once the storage system has been configured in accordance with procedure 600 of FIG. 6 and the cluster member has been supplied with the appropriate information in accordance with procedure 700 of FIG. 7, then the quorum program is downloaded from a storage system provider's website, or in another suitable manner, known to those skilled in the art, into the memory of the cluster member.

As noted, the quorum program is invoked when the cluster infrastructure determines that a new quorum is to be established. When this occurs, the quorum program contains instructions to send a command line with various input options to specify commands to carry out Persistent Reservation actions on the SCSI target device using a quorum enable command. The quorum enable command includes the following information:

```
Usage: quorum enable [-t target_hostname]
        [-T target_iscsi_node_name]
        [-I initiator_iscsi_node_name]
        [-i ISID] [-l lun] [-r resv_key] [-s serv_key]
        [-f file_name] [-o blk_ofst] [-n num_blks]
        [-y type] [-a] [-v] [-h] Operation
```

The options include “-h” which requests that the usage screen is printed; the option “-a” sets an APTPL bit to activate persist in case of a power loss; -f indicates the ‘file_name which specifies the file in which to read or write data; the option “-o blk_ofst” specifies the block offset in which to read or write data; the “-n num_blks” specifies a number of 512 byte blocks to read or write (128 max); the “-t target hostname” option specifies the target host name, with a default as defined by the operator; the “-T target_iscsi_node_name” option specifies a target iSCSI nodename, with an appropriate default; the “-I initiator_iscsi_node_name” -option specifies the initiator iSCSI node name and default: iqn.1992-08.com..itst; the “-i ISID” option specifies an Initiator Session ID (default 0); the “-I lun” option specifies the LUN (default 0); the option “-r resv_key” specifies the reservation key (default 0)’ and the “-s serv_key” -option specifies the service action resv key (default 0); the “-y type” specifies the reservation type (default 5); and -v is verbose.

The reservation types that can be implemented by the quorum enable command are as follows:

Reservation Types
1—Write Exclusive
2—Obsolete
3—Exclusive Access
4—Obsolete
5—Write Exclusive Registrants Only
6—Exclusive Access Registrants Only
7—Write Exclusive All Registrants
8—Exclusive Access All Registrants.

Operation is one of the following:
rk—Read Keys
rr—Read Reservations
rv—Reserve
cl—Clear
pa—Preempt Abort
in—Inquiry LUN Serial No.
rc—Read Capabilities
rg—Register
rl—Release
pt—Preempt
ri—Register Ignore

These codes conform to the SCSI-3 specification as will be understood by those skilled in the art.

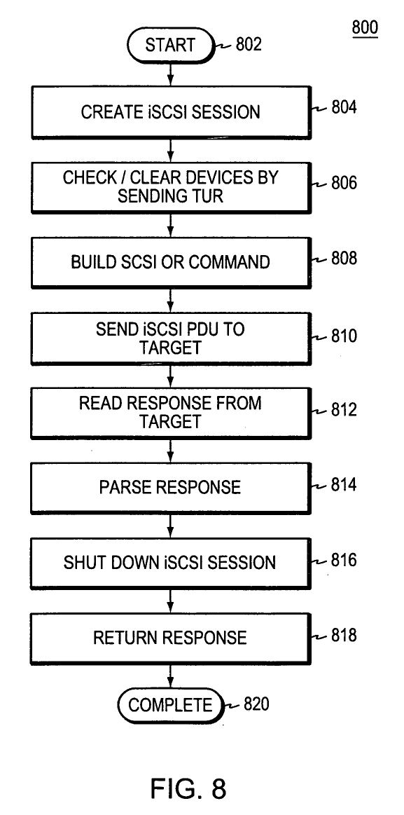

The quorum enable command is embodied in the quorum program 342a in cluster member 330a of FIG. 3 for example, and is illustratively based on the assumption that only one Persistent Reservation command will occur during any one session invocation. This avoids the need for the program to handle all aspects of iSCSI session management for purposes of simple invocation. Accordingly, the sequence for each invocation of quorum enable is set forth in the flowchart of FIG. 8.

The procedure 800 begins with the start step 802 and continues to 804 which are to create an iSCSI session. As noted herein, an initiator communicates with a target via an iSCSI session. A session is roughly equivalent to a SCSI initiator-target nexus, and consists of a communication path between an initiator and a target, and the current state of that communication (e.g. set of outstanding commands, state of each in-progress command, flow control command window and the like).

A session includes one or more TCP connections. If the session contains multiple TCP connections then the session can continue uninterrupted even if one of its underlying TCP connections is lost. An individual SCSI command is linked to a single connection, but if that connection is lost e.g. due to a cable pull, the initiator can detect this condition and reassign that SCSI command to one of the remaining TCP connections for completion.

An initiator is identified by a combination of its iSCSI initiator nodename and a numerical initiator session ID or ISID, as described herein before. After establishing this session, the procedure 800 continues to step 806 where a test unit ready (TUR) is sent to make sure that the SCSI target is available. Assuming the SCSI target is available, the procedure proceeds to step 808 where the SCSI PR command is constructed. As will be understood by those skilled in the art, iSCSI protocols embodied as protocol data units or PDUs.

The PDU is the basic unit of communication between an iSCSI initiator and its target. Each PDU consists of a 48-byte header and an optional data segment. Opcode and data segment length fields appear at fixed locations within the headers; the format of the rest of the header and the format and content of the data segment are not code specific. Thus the PDU is built to incorporate a Persistent Reservation command using quorum enable in accordance with the present invention. Once this is built, in accordance with step 810, the iSCSI PDU is sent to the target node, which in this instance is the LUN operating as a quorum device. The LUN operating as a quorum device then returns a response to the initiator cluster member. In accordance with step 814, the response is parsed by the initiator cluster member and it is determined whether the reservation command operation was successful. If the operation is successful, then the cluster member holds the quorum. If the reservation was not successful, then the cluster member will wait for further information. In either case, in accordance with step 816, the cluster member closes the iSCSI session. In accordance with step 818 a response is returned to the target indicating that the session was terminated. The procedure 800 completes at step 820.

### EXAMPLES

For purposes of illustration, this section provides some sample commands which can be used in accordance with the present invention to carry out Persistent Reservation actions on a SCSI target device using the quorum enable command. Notably, the commands do not supply the -T option. If the -T option is not included in the command line options then the program will use SENDTARGETS to determine the target ISCI nodename, as will be understood by those skilled in the art.

i). Two separate initiators register a key with the SCSI target for the first time and instruct the target to persist the reservation (-a option):

```
    # quorum enable -a -t target_hostname -s serv_key1 -r 0 -i ISID
-I initiator_iscsi_node_name -I 0 rg
    # quorum enable -a -t target hostname -s serv_key2 -r 0 -i ISID
-I intiator_iscsi_node_name -I 0 rg
```

ii). Create a WERO reservation on LUN0 (-1 option):

# quorum enable -t target_hostname -r resv_key -s serv_key -i
ISID -I initiator_iscsi_node_name -y 5 -l 0 rv

iii). Change the reservation from WERO to WEAR on LUN0:

# quorum enable -t targe_hostname -r resv_key -s serv_key -i
ISID -I initiator_iscis_node_name -y 7 -l 0 Pt

iv). Clear all the reservations/registrations on LUN0:

# quorum enable -r resv_key -a -i ISID -I initia-
tor iscsi_node_name cl

v). Write 2k of data to LUN0 starting at block 0 from the file foo

# quorum enable -f /u/home/temp/foo -n 4 -o 0 -i ISID -t tar-
get_hostname -I initiator_iscsi_node_name wr

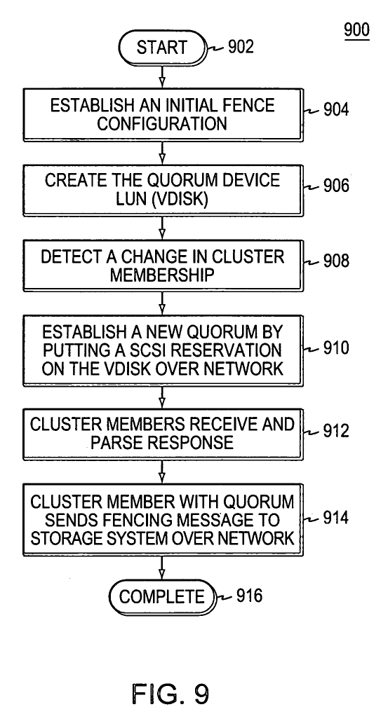

In accordance with an illustrative embodiment of the invention, the storage environment 300 of FIG. 3 can be configured such that each cluster member 330a and 330b also include a fencing program 340a and 340b respectively, which provide failure fencing techniques for file-based data, as well as a quorum facility as provided by the quorum programs 342a and 342b, respectively. A flowchart further detailing the method of this embodiment of the invention is depicted in FIG. 9.

The procedure 900 begins at the start step 902 and proceeds to step 904. In accordance with step 904 an initial fence configuration is established for the host cluster. Typically, all cluster members initially have read and write access to the exports of the storage system that are involved in a particular application of the invention. In accordance with step 906, a quorum device is provided by creating a LUN (vdisk) as an export on the storage system, upon which cluster members can place SCSI reservations as described in further detail herein.

During operation, as data is served by the storage system, a change in cluster membership is detected by a cluster member as in step 908. This can occur due to a failure of a cluster member, a failure of a communication link between cluster members, the addition of a new node as a cluster member or any other of a variety of circumstances which cause cluster membership to change. Upon detection of this change in cluster membership, the cluster members are programmed using the quorum program of the present invention to attempt to establish a new quorum, as in step 910, by placing a SCSI reservation on the LUN which has been created. This reservation is sent over the network using an iSCSI PDU as described herein.

Thereafter, a cluster member receives a response to its attempt to assert quorum on the LUN, as shown in step 912. The response will either be that the cluster member is in the quorum or is not in a quorum. A least one cluster member that holds quorum will then send a fencing message to the storage system over the network as show in step 914. The fencing message requests the NFS server of the storage system to change export lists of the storage system to disallow write access of the failed cluster member to given exports of the storage system. A server API message is provided for this procedure as set forth in the above incorporated United States Patent Application Numbers [Attorney Docket No. 112056-0236; P01-2299 and 112056-0237; P01-2252].

Once the cluster member with quorum has fenced off the failed cluster members or those as identified by the cluster infrastructure, the procedure 900 completes in step 916. Thus, a new cluster has been established with the surviving cluster members and the surviving cluster members will continue operation until notified otherwise by the storage system or the cluster infrastructure. This can occur in a networked environment using the simplified system and method of the present invention for interfacing a host cluster with a storage system in a networked storage environment. The invention provides for quorum capability and fencing techniques over a network without requiring a directly attached storage system or a directly attached quorum disk, or a fiber channel connection.

Thus, the invention provides a simplified user interface for providing a quorum facility and for fencing cluster members, which is easily portable across all Unix®-based host platforms. In addition, the invention can be implemented and used over TCP with insured reliability. The invention also provides a means to provide a quorum device and to fence cluster members while enabling the use of NFS in a shared collaborative clustering environment. It should be noted that while the present invention has been written in terms of files and directories, the present invention also may be utilized to fence/unfence any form of networked data containers associated with a storage system. It should be further noted that the system of the present invention provides a simple and complete user interface that can be plugged into a host cluster framework which can accommodate different types of shared data containers. Furthermore, the system and method of the present invention supports NFS as a shared data source in a high-availability environment that includes one or more storage system clusters and one or more host clusters having end-to-end availability in mission-critical deployments having substantially constant availability.

The foregoing has been a detailed description of the invention. Various modifications and additions can be made without departing from the spirit and scope of the invention. Furthermore, it is expressly contemplated that the various processes, layers, modules and utilities shown and described according to this invention can be implemented as software, consisting of a computer readable medium including programmed instructions executing on a computer, as hardware or firmware using state machines and the like, or as a combination of hardware, software and firmware. Accordingly, this description is meant to be taken only by way of example and not to otherwise limit the scope of the invention.

What is claimed is:

1. A method of providing a quorum facility in a networked, host-clustered storage environment, comprising the steps of:
providing a plurality of nodes configured in a cluster for sharing data, each node being a cluster member;
providing a storage system that supports a plurality of data containers, said storage systems supporting a protocol to provide access to each respective data container associated with the storage system;
creating a logical unit (LUN) on the storage system as a quorum device;
mapping the logical unit to an iSCSI group of initiators which group is made up of the cluster members;
coupling the cluster to the storage system;
providing a quorum program in each cluster member such that when a change in cluster membership is detected, a surviving cluster member is instructed to send a message to an iSCSI target to place a SCSI reservation on the LUN; and
if a cluster member of the igroup is successful in placing the SCSI reservation on the LUN, then quorum is established for that cluster member.

2. The method as defined in claim 1 wherein said protocol used by said networked storage system is the Network File System protocol.

3. The method as defined in claim 1 wherein the cluster is coupled to the storage system over a network using Transmission Control Protocol/Internet Protocol.

4. The method as defined in claim 1 wherein said cluster member transmits said message that includes an iSCSI Protocol Data Unit.

5. The method as defined in claim 1 further comprising the step of said cluster members sending messages including instructions other than placing SCSI reservations on said quorum device.

6. The method as defined in claim 1 wherein said SCSI reservation is a Persistent Reservation.

7. The method as defined in claim 1 wherein said SCSI reservation is a Reserve/Release reservation.

8. The method as defined in claim 1 including the further step of employing an iSCSI driver in said cluster member to communicate with said LUN instead of or in addition to said quorum program.

9. A method for performing fencing and quorum techniques in a clustered storage environment, comprising the steps of:
providing a plurality of nodes configured in a cluster for sharing data, each node being a cluster member;
providing a storage system that supports a plurality of data containers, said storage system supporting a protocol that configures export lists that assign each cluster member certain access permission rights, including read write access permission or read only access permission as to each respective data container associated with this storage system;
creating a logical unit (LUN) configured as a quorum device;
coupling the cluster to the storage system;
providing a fencing program in each cluster member such that when a change in cluster membership is detected, a surviving member send an application program interface message to said storage system commanding said storage system to modify one or more of said export lists such that the access permission rights of one or more identified cluster members are modified; and
providing a quorum program in each cluster member such that when a change in cluster membership is detected, a surviving cluster member transmits a message to an iSCSI target to place the a SCSI reservation on the LUN.

10. A system of performing quorum capability in a storage system environment, comprising:
one or more storage systems coupled to one or more clusters of interconnected cluster members to provide storage services to one or more client;
a logical unit exported by said storage system and said logical unit being configured as a quorum device; and
a quorum program running on one or more cluster members including instructions such that when cluster membership changes, each cluster member asserts a claim on the quorum device by sending an iSCSI Protocol Data Unit message to place an iSCSI reservation on the logical unit serving as a quorum device.

11. The system as defined in claim 10 wherein said one or more storage systems are coupled to said one or more clusters by way of one or more networks that use the Transmission Control Protocol/Internet Protocol.

12. The system as defined in claim 10 wherein said storage system is configured to utilize the Network File System protocol.

13. The system as defined in claim 10 further comprising:
a fencing program running on one or more cluster members including instructions for issuing a host application program interface message when a change in cluster membership is detected, said application program interface message commanding said storage system to modify one or more of said export lists such that the access permission rights of one or more identified cluster members are modified.

14. The system as defined in claim 10 further comprising an iSCSI driver deployed in at least on of said cluster members configured to communicate with said LUN.

15. A computer readable medium for providing quorum capability in a clustered environment with networked storage system, including program instructions for performing the steps of:
creating a logical unit exported by the storage system which serves as a quorum device;
generating a message from a cluster member in a clustered environment to place a reservation on said logical unit which serves as a quorum device; and
generating a response to indicate whether said cluster member was successful in obtaining quorum.

16. The computer readable medium for providing quorum capability in a clustered environment with networked storage, as defined in claim 15 including program instructions for performing the further step of issuing a host application program interface message when a change in cluster membership is detected, said application program interface message commanding said storage system to modify one or more export lists such that access permission rights of one or more identified cluster members are modified.

17. A computer readable medium for providing quorum capability in a clustered environment with a networked storage system, comprising program instructions for performing the steps of:
detecting that cluster membership has changed;
generating a message including a SCSI reservation to be placed on a logical unit serving as a quorum device in said storage system; and
upon obtaining quorum, generating a message that one or more other cluster members are to be fenced off from a given export.

18. The computer readable medium as defmed in claim 17 further comprising instructions for generating an application program interface message including a command for modifying export lists of the storage system such that an identified cluster member no longer has read-write access to given exports of the storage system.

19. The computer readable medium as defined in claim 17 further comprising a cluster member obtaining quorum by successfully placing a SCSI reservation on a logical unit serving as a quorum device before such a reservation is placed thereupon by another cluster member.

20. The computer readable medium as defined in claim 17 further comprising instructions in a multiple node cluster having more than two cluster members to establish a quorum in a partitioned cluster by appointing a representative cluster member and having that cluster member place a SCSI reservation on a logical unit serving as a quorum device prior to a reservation being placed by another cluster member.
